(19) United States
(12) Patent Application Publication
(10) Pub. No.: US 2005/0206036 A1
(43) Pub. Date: Sep. 22, 2005

(54) Method for producing a throttle valve

(75) Inventor: Armin Seeger, Glashuetten (DE)

Correspondence Address: SIEMENS SCHWEIZ;I-44, INTELLECTUAL PROPERTY, ALBISRIEDERSTRASSE 245, ZURICH, CH-8047, CH

(73) Assignee: SIEMENS AKTIENGESELLSCHAFT, MUNICH (DE)

(21) Appl. No.: 11/111,950

(22) Filed: Apr. 22, 2005

Related U.S. Application Data
(63) Continuation of application No. PCT/DE03/03290, filed on Oct. 2, 2003.

(30) Foreign Application Priority Data
Nov. 27, 2002 (DE) 10 255 339.4

(51) Int. Cl. B29C 45/16

(52) U.S. Cl. 264/242; 264/255

(57) ABSTRACT

The inventive method provides that during a first step, a circular, discoidal pre-molding is produced from a first plastic by injection molding. After the pre-molding is hardened, a ring made of a second plastic is subsequently placed, by injection molding, on the pre-molding while encircling the narrow side of the pre-molding and is hardened as well. The invention also relates to an application of the method.

The invention relates to a method for producing a throttle valve and to a use of the method.

Throttle valves in throttle valve bodies are known. In DE 195 12 729 A1 a description is given of a throttle valve body with a tubular housing, in which a throttle valve is fastened on a throttle valve shaft, which is rotatably mounted at its free ends transversely in relation to the longitudinal axis of the tubular housing in such a way that it can be led through clearances in the housing wall. The arrangement of the throttle valves in throttle valve bodies is often disadvantageous in that, on account of sometimes extremely small leakage allowances, it is necessary to work with high precision and surface quality in order to avoid formation of leakage air. The throttle valve is in this case generally punched from a metal sheet and turned on a lathe to produce a super-finish, involving great precision and the observance of very small tolerances. It must in this case be ensured that the throttle valve lies with the closest possible contact against the inner wall of the throttle valve body, but is not too firmly in contact with the inner wall, since otherwise jamming of the throttle valve may occur. To simplify the method for producing the throttle valve, there has in the meantime been a change to producing the throttle valve from plastic. On account of the shrinkage behavior of the plastics used for this, however, it is particularly difficult to maintain the required tolerances. Therefore, secondary finishing of the throttle valve produced from plastic is generally imperative.

The invention is therefore based on the object of providing a method for producing a throttle valve with which it is possible to dispense largely with secondary finishing of the throttle valve.

The invention is also based on the object of providing a use of the method.

The object on which the invention is based is achieved by a method for producing a throttle valve in which, in a first step, a circular, disk-shaped preform is produced from a first plastic by injection molding, and subsequently, after curing of the preform, in a second step, a ring of a second plastic is arranged around the narrow side of the preform by injection molding on the preform and is likewise made to cure. Plastics which can be processed by injection molding and which have a temperature resistance up to 150° C. may be used here as the first plastic or as the second plastic. In the actual injection molding, multi-component molds are used. It has surprisingly been found that the problem of the relatively great shrinkage of plastic can be avoided by the two-stage injection-molding process. This is achieved by the greater part of the shrinkage taking place on the preform which is produced in the first step of the method. The shrinkage of the ring subsequently to be arranged in the second step is much less, so that the required tolerances can be set in a relatively simple way, secondary finishing of the finished throttle valve not being required. In addition, the method can be carried out relatively easily and at low cost.

A preferred refinement of the invention consists in that a polyphenylene sulfide mixed with fillers or a polyphthalamide mixed with fillers or a polybutylene terephthalate mixed with glass fibers or a polyether ketone mixed with glass fibers or a polyamide mixed with glass fibers is used as the first plastic and silicone rubber or fluororubber or the first plastic respectively mixed with 12 to 16% by weight of polytetrafluoroethylene is used as the second plastic. The fillers generally comprise a mixture of glass fibers and minerals. Their proportion is in this case generally above 60% by weight. It is in this respect advantageous that the throttle valve has a relatively high hardness and at the same time is somewhat softer at the edge, which is beneficial in maintaining the required close tolerances. The proportion of glass fibers may be, for example, 30 or 50% by weight.

According to a further preferred refinement of the invention, it is provided that the first plastic respectively is used as the second plastic. The use of the same plastics in each case in the first step and in the second step of the method makes it easier to carry out the method, while avoidance of leakage air is ensured to an adequate extent.

According to a further refinement of the invention, a polyphenylene sulfide mixed with fillers with a proportion of fillers of 64 to 66% by weight is used as the first plastic. This allows the formation of leakage air to be avoided virtually completely. At the same time, a relatively high hardness of the throttle valve is ensured.

According to a further preferred refinement of the invention, in the second step, a ring with a width of 1 to 3.5 mm is arranged. A preferred width of the ring is in this case 3 mm. With this ring width, there is only a relatively small shrinkage of the plastic in the cooling phase, which makes it easier especially to maintain the low tolerances.

According to a further preferred refinement of the invention, it is provided that, in the first step, a peripheral projection is arranged on the narrow side of the preform.

This peripheral projection generally extends centrally. The formation of the projection in the first step facilitates the bonding between the preform and the ring which in the second step is arranged around the narrow side of the preform by injection molding.

Finally, the invention relates to the use of the method for producing a throttle valve for a throttle valve body of plastic. There has recently been a change to producing the throttle valve body no longer from cast material but from plastic. On account of the material affinity, the method for producing a throttle valve is particularly suitable for producing throttle valves which are arranged in a throttle valve body of plastic.

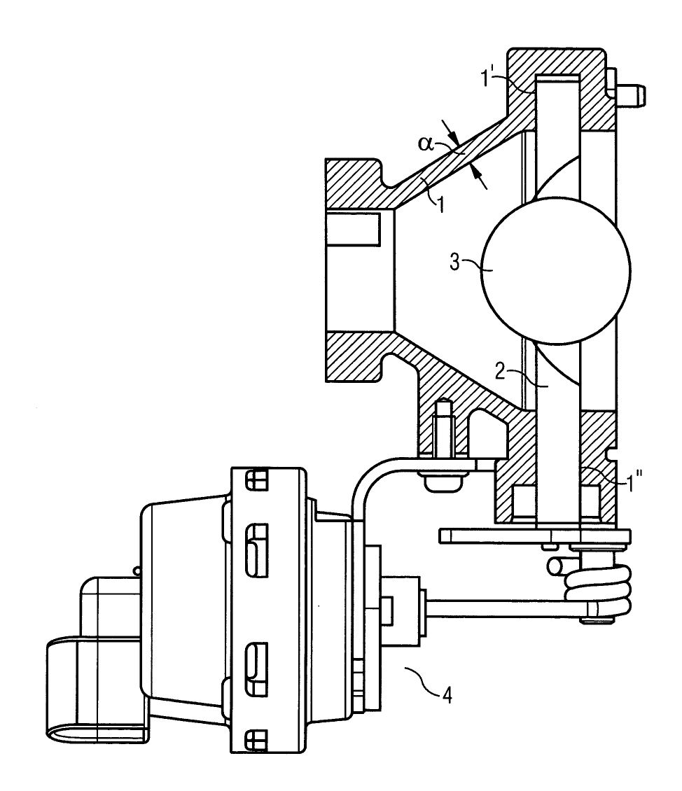

The invention is explained below in more detail and by way of example on the basis of the drawing (FIG. 1, FIG. 2).

FIG. 1 shows half of a throttle valve produced by the method in cross section.

FIG. 2 shows a throttle valve produced by the method in plan view.

In FIG. 1, half of a throttle valve produced by the method is represented in cross section, in a simplified, schematic form. In the case of the method for producing a throttle valve, in a first step, a circular, disk-shaped preform 1 is produced from a first plastic by injection molding. After curing of the preform 1, subsequently, in a second step, a ring 2 of a second plastic is arranged around the narrow side of the preform 1, by injection molding on the preform 1, and is likewise made to cure. The width of the ring 2 lies in the range from 1 to 3.5 mm. It is advantageous in this respect if, in the first step, a peripheral projection 1′ is arranged on the narrow side of the preform 1. By this measure, the bonding between the preform 1 and the ring 2 is intensified.

In FIG. 2, the plan view of a throttle valve with the preform 1 and the arranged ring 2 is represented in a simplified form. Such a throttle valve is suitable in particular for use in a throttle valve body of plastic.

1. A method for producing a throttle valve in which, in a first step, a circular, disk-shaped preform is produced from a first plastic by injection molding, and subsequently, after curing of the preform, in a second step, a ring of a second plastic is arranged around the narrow side of the preform by injection molding on the preform and is likewise made to cure, characterized in that a polyphenylene sulfide mixed with fillers or a polyphthalamide mixed with fillers or a polybutylene terephthalate mixed with glass fibers or a polyether ketone mixed with glass fibers or a polyamide mixed with glass fibers is used as the first plastic and the first plastic respectively or silicone rubber or fluororubber or the first plastic respectively mixed with 12 to 16% by weight of polytetrafluoroethyene is used as the second plastic, the ring with a width of 1 to 3.5 mm being arranged in the second step.

2. (canceled)

3. (canceled)

4. The method as claimed in claim 1, in which a polyphenylene sulfide mixed with fillers with a proportion of fillers of 64 to 66% by weight is used as the first plastic.

5. (canceled)

6. The method as claimed in one of claim 1, in which, in the first step, a peripheral projection is arranged on the narrow side of the preform.

7. (canceled)
